(19) United States
(12) Patent Application Publication
(10) Pub. No.: US 2005/0060117 A1
(43) Pub. Date: Mar. 17, 2005

(54) Method and device for determination of the distance of a sensor device to an object

(75) Inventors: Frank Kunzler, Kraichtal (DE); Timo Brandt, Heilbronn (DE); Udo Haberland, Holzgerlingen (DE)

Correspondence Address: DREISS, FUHLENDORF, STEIMLE & BECKER, POSTFACH 10 37 62, D-70188 STUTTGART, DE

(73) Assignee: Valeo Schalter und Sensoren GmbH, Bietigheim-Bissingen (DE)

(21) Appl. No.: 10/921,103

(22) Filed: Aug. 19, 2004

(30) Foreign Application Priority Data
Sep. 12, 2003 (DE) 103 42 128.9

(51) Int. Cl. G01P 11/00

(52) U.S. Cl. 702/149

(57) ABSTRACT

The invention concerns a method and a distance determination device for determining the distance between at least one sensor device and an object in the detection region of the sensor device. A conventional method of this type is further developed in accordance with the invention in order to decide whether or not there is the danger of collision due to a relative motion between the object and the sensor device. This danger of collision is determined in accordance with the invention by means of a threshold value comparison between the change of a relative speed determined by the sensor device between the object and the sensor device and a predetermined change threshold value.

This application claims Paris Convention priority of DE 103 42 128.9 filed Sep. 12, 2003 the complete disclosure of which is hereby incorporated by reference.

### BACKGROUND OF THE INVENTION

The invention concerns a method and a computer program for determining a distance between at least one sensor device and an object in the vicinity of the sensor device. The invention also concerns a device for determination of a distance for carrying out this method, preferably using the computer program and a data carrier for storing the computer program.

Methods and devices of this type are known in the art, in particular, in the field of automotive vehicles. Radar sensors are conventionally used to determine the radial distance between the sensor and an object to be detected. If an object has been localized in the detection range of a radar sensor disposed in the front region of a vehicle, a decision must be made as to whether or not there is a danger of collision between the object and the vehicle. This is conventionally effected through evaluation of the signals of several radar sensors and generally through additional evaluation of distance information history. As an alternative to using several sensors, only one radar sensor may be used. In addition to the information concerning its distance from the detected object, the sensor must also provide angle information e.g. in the form of the angle between the line connecting the object and sensor device and the direction of motion of the object. Current radar sensors are usually not suited to provide such additional information, rather are only designed to detect the radial distance from the object or the relative speed with respect to the object and not the lateral distance and the forward distance relative to the sensor.

DE 197 54 220 A1 discloses a method and device for recognizing and evaluating an impending collision between a motor vehicle and an obstacle. A FMCW radar detects the obstacle in the form of a spectral line. A suitable filtering produces a time dependence of amplitudes of the spectral line and the time dependence is recorded. A comparison between a current recorded time dependence and stored characteristic time dependences permits determination of a sideward distance between the motor vehicle and the obstacle. Alternatively or in addition thereto, the sideward distance can also be determined using characteristic time dependences of relative speed values.

DE 196 38 387 A1 describes a method for recognizing collisions between vehicles using Doppler Radar Devices which are disposed at spatial separations from each other on the vehicle. The relative path of motion is determined through analysis of the relative velocity between an object and the device as a function of time.

DE 33 37 135 A1 discloses a collision avoidance system for motor vehicles having a pair of radar devices mounted to the vehicle which produce two Doppler signals in response to the motion of an object. A differential device determines a distance between the object and the vehicle through analysis of a phase difference between the two signals to assess a risk of collision.

U.S. Pat. No. 6,615,138 discloses a collision detection system and a method of estimating a miss distance to an object. A detection system determines a distance and a speed of the sensed object and a controller computes a mathematical square of the range and of a product between the range and the speed to estimate a miss distance to the object.

Based on this prior art, it is the underlying purpose of the invention to provide a method, a computer program, a data carrier comprising this computer program, and a distance determination device which permit determination of the minimum lateral distance during relative motion between a sensor device and an object in the detection range of the sensor device using only one sensor device, wherein this sensor device must only provide the relative speed between itself and the object.

### SUMMARY OF THE INVENTION

This object is achieved by the method claimed in claim 1. This method is characterized in that the sensor signal is constant in time with regard to its frequency, amplitude and phase. The evaluation of the sensor signal comprises the following steps:

Determination of the time behavior of the relative speed between the sensor device and the object; comparison of the change in the relative speed to a predetermined change threshold value; and concluding that the minimum lateral distance which is measured substantially transverse with respect to a direction of motion of the sensor device or object and at which the sensor device and the object move past each other during their relative motion, is sufficiently large to preclude any danger of collision, if the change with time of the relative speed exceeds the predetermined change threshold value.

The claimed method advantageously permits a decision concerning whether or not there is a risk of collision between the sensor device and the object moving relative thereto, only through evaluation of the change of their relative mutual speeds. The sensor device must therefore only determine the relative speed between itself and the object. There is a danger of collision if the minimum lateral distance between the object and the sensor device during mutual relative motion is not sufficiently large. Whether or not this is the case is decided in accordance with the invention through comparison of the dependence of the change in the relative speed versus time to the change threshold value.

The method as claimed functions with particular precision at high relative speeds, since high relative speeds produce larger changes in relative speed than smaller relative speeds and since the detected larger change in relative speed permits a more precise conclusion as to whether the predetermined change threshold value has been exceeded or fallen below and concerning the risk of a collision.

The method as claimed also permits good separation between two detected objects which are located close to each other at the time of detection but which move at different speeds relative to each other. This advantage also results from the fact that the inventive method evaluates the change of the relative speed between an object and the sensor device.

The determination, provided by the method as claimed, as to whether or not there is a danger of collision between the object and the sensor device as they approach each other at too small a lateral separation during their relative motion can be confirmed or denied using various subsequent likelihood tests.

One first possible likelihood test preferably consists in checking whether the value of the detected relative speed between the detected object which will move past the side of the sensor device, and the sensor device is smaller than the value of a relative speed between the sensor device and a fictitious or imaginary object located in front of the sensor device as viewed in its direction of motion.

A second possible likelihood test is a precise calculation of the size of the lateral distance at which the sensor device and the object will move past each other during the course of their relative mutual motion.

The use of two sensor devices which function in accordance with the claimed inventive method advantageously provides a conclusion as to whether or not the object will pass the left-hand or right-hand side of the sensor device through determination of the difference between the respective relative speeds between them and the object as determined by these two sensor devices. This position of the object can be expressed using different coordinate systems. Depending on the coordinate system used, the angle φ at which the object moves relative to the two sensor devices, can be used as a parameter which characterizes the position of the object. This angle φ can be read from a diagram plotting the dependence of the percentage ratio between the relative speeds, as determined by the two spaced apart sensor devices, versus the distance from the object.

Predetermined safety measures are preferably activated or triggered as early as possible if the inventive method determines that there is a danger of collision between the object and the sensor device due to their relative mutual motion.

The above-mentioned object of the invention is further achieved by a computer program, a data carrier comprising the computer program, and a distance determination device, each for carrying out the claimed method. The advantages of these solutions correspond to the advantages mentioned above in connection with the claimed method.

A total of six figures are enclosed with the description.

### BRIEF DESCRIPTION OF THE DRAWING

FIG. 1 shows a problematic situation on which the invention is based;

FIG. 2 shows an arrangement of a sensor device and an object which form the basis of the invention;

FIG. 3 shows the dependence of the relative speeds between a sensor device and an object versus time;

FIG. 4 shows an arrangement of two sensor devices and an object relative to each other;

FIG. 5 shows the percentage ratio of the speeds relative to an object measured by two sensor devices versus the distance between the object and the sensor devices for different angles φ; and

FIG. 6 shows the percentage ratio of the speeds relative to an object measured by two sensor devices versus the distance between the object and the sensor devices for different distances between the sensor devices.

### DESCRIPTION OF THE PREFERRED EMBODIMENT

The invention is described in more detail below with reference to the mentioned figures.

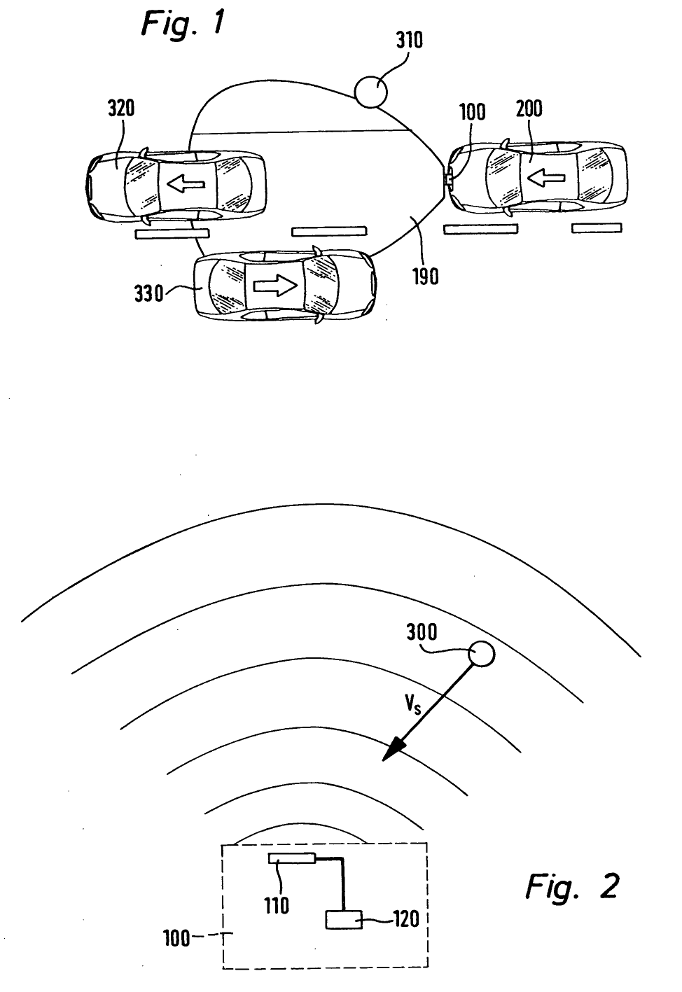

FIG. 1 shows an every day road traffic situation illustrating the problem on which the invention is based. The rear vehicle 200 has a distance determination device 100 in accordance with the invention. The conical detection range thereof has the reference numeral 190 in FIG. 1. It radiates in the travelling direction of the vehicle 200 where it detects an object 310, a vehicle 320 travelling ahead, and a vehicle 330 heading towards it in another lane. The distance determination device 100 must not only detect the objects 310, 320, 330 but also evaluate which or which ones of these objects represent(s) a possible collision danger for the vehicle 200.

In the situation of FIG. 1, the objects 310 and 330 would not represent a serious danger of collision. The case is different for the vehicle 320 travelling ahead. In particular, if this vehicle moves slower than the following vehicle 200, there would, in principle, be a risk of collision.

It is now possible to evaluate this danger of collision using the inventive method using only one sensor device 110, which is preferably a component of the distance determination device 100. The sensor device for use in the field of automotive vehicles is preferably a radar transmitter and receiver. As an alternative to sensor devices based on radar technology, sensor devices based on other suitable technologies such as e.g. laser light or ultrasound can also be used to carry out the inventive method.

FIG. 2 shows an initial situation for application of the present invention. The sensor device 110 transmits a sensor signal and receives at least parts thereof after reflection on an object 300 within the detection range of the sensor device 110. The sensor device within the distance detection device 100 is followed by an evaluation device 120 for evaluation of the transmitted and received sensor signal. The sensor signal transmitted by the sensor device 110 is constant in time with regard to frequency, amplitude and phase. This requirement for the transmitted sensor signal is particularly easy to realize, since no additional modulation devices are required. In this way, the sensor device for the present invention can be realized in a particularly inexpensive manner. The evaluation device 120 in accordance with the invention is designed to process the sensor signal transmitted and received by the sensor device 110 to calculate the time dependence of the relative speed Vₛ between the sensor device 110 and the object.

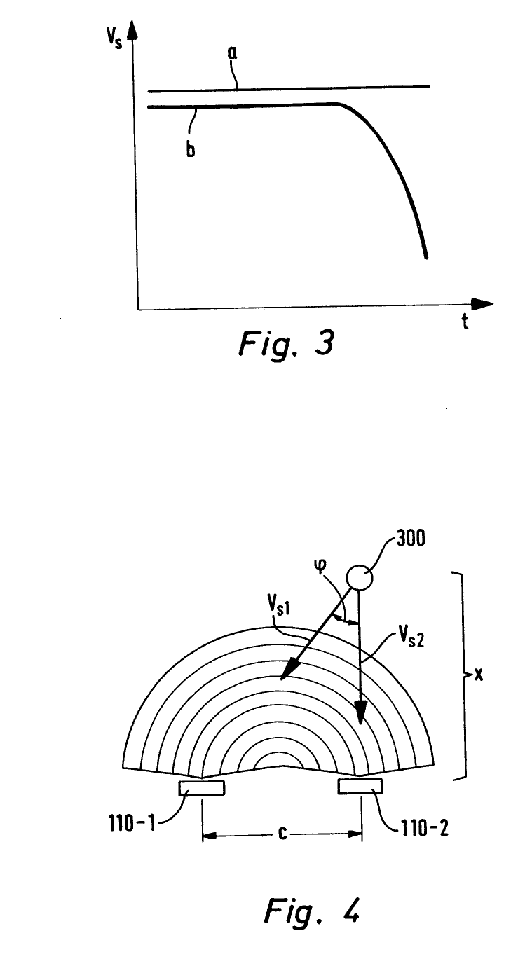

FIG. 3 shows two examples of the time behavior of the relative speeds for different sensor device 110 and object 300 constellations.

The curve a shows a temporally constant behavior for the relative speed. Such a behavior is typically given when the object 300 stops in front of the sensor device 110, and the sensor device, which is e.g. installed in the vehicle 200, moves towards the object 300 at a constant speed. In this case, the relative speed Vₛ corresponds to the speed of the vehicle 200. A collision between the sensor device 110 and the object 300 will be unavoidable within a short time.

In contrast thereto, curve b in FIG. 3 represents another constellation between the sensor device 110 and the object 300. With an initially large distance between the sensor device 110 and the object 300, the angular change during motion of the sensor device 110 and the object 300 relative to each other is still very small. As a result, the relative speed Vₛ between the object 300 and the sensor device 110 is also substantially constant. As the sensor device 110 and the object 300 approach each other during their relative motion and begin to move past each other, a clear reduction in the relative speed occurs due to the increasing influence of the Doppler effect. FIG. 3 clearly shows this Doppler effect influence through a bend in curve b.

In accordance with the invention, the change in the relative speed between the object 300 and the sensor device 110 as represented by the bend in the curve in FIG. 3 is used to be able to obtain an unambiguous conclusion concerning a possible danger of collision between the object 300 and the sensor device 110. To be more precise, the change of the relative speed, i.e. the increase in the tangent to the curve b in FIG. 3, is compared to a predetermined change threshold value. Should the change in relative speeds exceed this predetermined change threshold value, one can assume that the object 300 will move past the sensor device 110 in the course of its relative motion with respect to the sensor device 110 at a sufficiently large minimum lateral distance. This lateral distance is measured substantially transverse to the direction of motion of the sensor device or of the object. There is no danger of collision in this case. The danger of collision occurs in the opposite case, i.e. when the determined change of relative speed does not exceed the predetermined change threshold value.

As shown in FIG. 3, the value of the relative speed in curve a, which represents a greater risk of collision, is larger than the value of the relative speed of the substantially constant part of curve b which represents only a slight risk of collision due to the later change in relative speed. This situation permits a likelihood test concerning a previous statement in accordance with the inventive method as to whether or not a collision will occur for a certain constellation between the object 300 and the sensor device 110. Such a statement, initially made on the basis of the described threshold value comparison, can be examined for likelihood through comparison of the values of the relative speeds of the measured curve b with the known curve a, if the value of the relative speeds in the constant portion of the curve b is smaller than the value of the relative speed of curve a.

A further possibility for verifying the statement made on the basis of the threshold value comparison that there is no danger of collision can consist of exactly determining the minimum lateral distance at which the object will move past the sensor device 110. Such a precise determination of the distance can be achieved by means of two sensor devices whose sensor signals are evaluated using the conventional triangulation method. Another possibility to determine this distance is the use of a sensor device which transmits a sensor signal of constant frequency, amplitude and phase in accordance with the invention, if the radial distance between the object 300 and the sensor device 110 is also known. This radial distance can be determined e.g. immediately before by means of the known triangulation method or through distance measurement using a modulated signal (e.g. pulse-travel time measurement), generated by the same sensor device.

FIG. 4 shows the use of two sensor devices 110-1 and 110-2 for detecting the object 300. Evaluation of their respective sensor signals determines a first relative speed Vₛ₁ between the first sensor device 110-1 and the object 300 and a second relative speed Vₛ₂ between the second sensor device 110-2 and the object 300. The sign of the difference between these two relative speeds Vₛ₁ and Vₛ₂ permits conclusion as to whether the object 300 will pass the left-hand or right-hand side of the sensor devices during its relative motion with respect to the sensor devices 110-1 and 110-2, which, in turn, have a fixed mutual separation.

Moreover, a percentage ratio of these two relative speeds Vₛ₁ and Vₛ₂ permits conclusions concerning the angle φ at which the object moves relative to the two sensor devices. The percentage ratio Vᵥ is calculated in accordance with the following formula:
Vᵥ=(Vₛ₂/Vₛ₁1)·100.

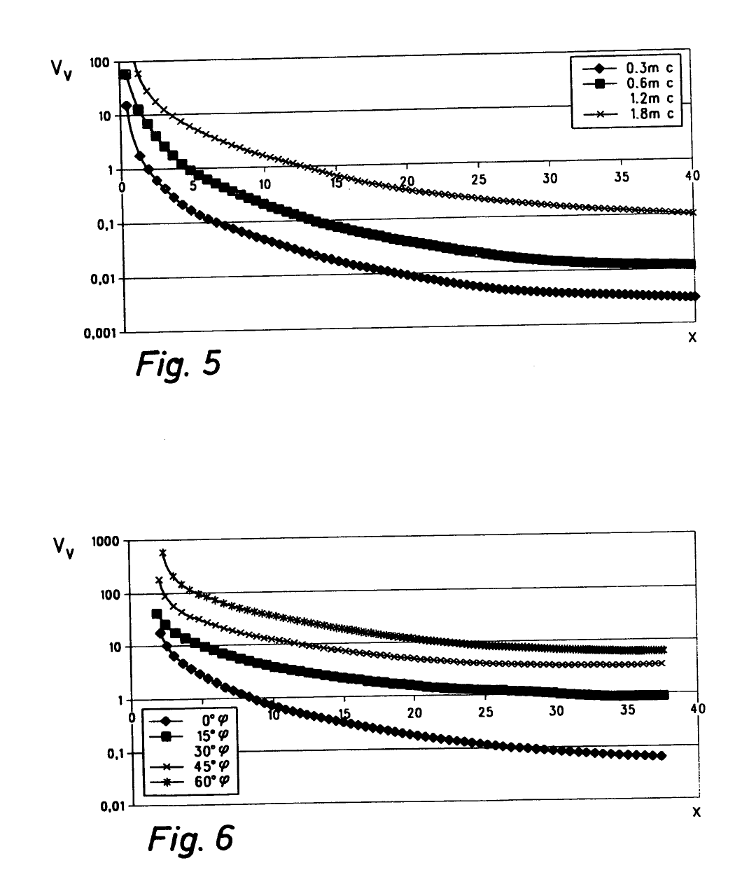

FIG. 5 shows the position and the dependence of the curve illustrating changes in the ratio Vᵥ versus the forward distance x between the sensor devices 110-1, 110-2 and the object 300 for various distances c between the two sensor devices. This also means that, when the distance c between the sensor devices 110-1 and 110-2 is constant, the angle φ at which the object 300 moves relative to the two sensor devices 110-1 and 110-2 is represented by the position of the curve in the Vᵥ/x diagram (see FIG. 6).

The findings obtained through application of the inventive method, concerning whether or not there is a danger of collision, are used to initiate early suitable safety measures either to prevent a collision or to weaken the effects of a presumably unavoidable collision on the passengers of a vehicle which is in danger of collision. These measures could be realized through issuing an optical or acoustical warning of collision to the driver, activating a seat belt tightener or triggering of an airbag.

The inventive method is advantageously realized in the form of a computer program which may run on a suitable calculation device in the distance determination device 100. The computer program can optionally be stored together with further programs for the distance determination device on a computer-readable data carrier. The data carrier may be a disk, a compact disc, a flash memory or the like. The computer program stored on the data carrier can be sold as product to a customer. Alternatively, the computer program can be transmitted and sold as product to a customer without the aid of an electronic data carrier, via an electronic communications network, in particular the Internet.

1. A method for determining a distance between at least one sensor device and an object in a detection region of the sensor device, the method comprising the steps of:
a) transmitting a sensor signal via the sensor device toward the object, the sensor signal being constant in time with regard to a frequency, an amplitude and a phase thereof;
b) receiving a portion of the sensor signal reflected from the object;
c) determining a time behavior of a relative speed (Vₛ) between the sensor device and the object;
d) comparing a change of the relative speed to a predetermined change threshold value; and
e) concluding that a minimum lateral separation, measured substantially transversely to a direction of motion of the sensor device or the object, at which the sensor device and the object move past each other during their relative motion is sufficiently large to prevent a collision should a change in time of the relative speed (Vₛ) exceed the predetermined change threshold value.

2. The method of claim 1, further comprising performing a likelihood test of step e), that the object and the sensor device will move laterally past each other without collision during their relative motion, by examining whether a value of the relative speed between the object and the sensor device is smaller than a value of a relative speed between a fictitious object located in front of the sensor device, viewed in the direction of motion, and the sensor device.

3. The method of claim 2, wherein the likelihood test of the conclusion that the object and the sensor device will laterally pass each other without collision during their relative motion, comprises calculation of a position of the object relative to the sensor device through evaluation of the relative speed together with an independently determined distance between the object and the sensor device.

4. The method of claim 3, wherein a minimum lateral distance between the object and the sensor device is calculated.

5. The method of claim 1, wherein the sensor signal is transmitted towards the object from each of a first and a second sensor device, the first and second sensor devices having a fixed distance from each other, and a first relative speed (Vₛ₁) between the object and the first sensor device as well as a second relative speed (Vₛ₂) between the object and the second sensor device are calculated and a difference between the first and the second relative speeds (Vₛ₁, Vₛ₂) is subsequently determined, wherein a sign of the difference indicates whether the object will pass a right-hand or a left-hand side of the first and second sensor devices during relative motion with respect to the sensor devices.

6. The method of claim 1, wherein one sensor signal is transmitted towards the object from each of a first and a second sensor device, the first and the second sensor devices being positioned at a known fixed mutual distance, and a first relative speed (Vₛ₁) between the object and the first sensor device as well as a second relative speed (Vₛ₂) between the object and the second sensor device are calculated, wherein a lateral distance and/or a forward distance (x) between the object and the sensor devices are determined through evaluation of the first and the second relative speeds (Vₛ₁, Vₛ₂) and the known fixed distance between the first and the second sensor devices using triangulation.

7. The method of claim 1, wherein one sensor signal is transmitted towards the object from each of a first and a second sensor device, wherein the first and the second sensor devices are positioned at a known fixed mutual separation, and a first relative speed (Vₛ₁) between the object and the first sensor device as well as a second relative speed (Vₛ₂) between the object and the second sensor device are calculated, wherein a behavior of a percentage ratio between the first and the second relative speeds (Vₛ₁, Vₛ₂) is determined as a function of a forward distance (x) between the object and the first and second sensor devices, an angle φ at which the object moves relative to the first and the second sensor devices being subsequently calculated using a ratio/distance diagram.

8. The method of claim 1, further comprising triggering predetermined safety measures if a minimum lateral distance is insufficient and a danger of collision between the object and the at least one sensor device is determined.

9. The method of claim 8, wherein the safety measures include at least one of activation of a seat belt tightener or triggering an airbag.

10. The method of claim 8, further comprising confirmation of the minimum lateral distance using likelihood test.

11. A computer program comprising a program code for a distance determination device, wherein the program code is designed to carry out the method in accordance with claim 1.

12. A data carrier comprising the computer program of claim 11.

13. A device for determining a distance between at least one sensor device and an object in a detection region of the sensor device, the device comprising:
means for transmitting a sensor signal via the sensor device toward the object, the sensor signal being constant in time with regard to a frequency, an amplitude and a phase thereof;
means for receiving a portion of the sensor signal reflected from the object;
means for determining a time behavior of a relative speed (Vₛ) between the sensor device and the object;
means for comparing a change of the relative speed to a predetermined change threshold value; and
means for concluding that a minimum lateral separation, measured substantially transversely to a direction of motion of the sensor device or the object, at which the sensor device and the object move past each other during their relative motion is sufficiently large to prevent a collision should a change in time of the relative speed (Vₛ) exceed the predetermined change threshold value.
